(19) United States
(12) Patent Application Publication
(10) Pub. No.: US 2025/0241301 A1
(43) Pub. Date: Jul. 31, 2025

(54) COMPOSITIONS AND METHODS FOR INHIBITING PATHOGEN GROWTH ON PLANTS AND IMPROVING CROP SAFETY

(71) Applicant: AMVAC Chemical Corporation, Newport Beach, CA (US)

(72) Inventors: John A. Immaraju, Newport Beach, CA (US); Peter P. Porpiglia, Newport Beach, CA (US)

(21) Appl. No.: 19/033,733

(22) Filed: Jan. 22, 2025

Related U.S. Application Data
(60) Provisional application No. 63/623,931, filed on Jan. 23, 2024.

(51) Int. Cl. A01N 35/02; A01N 25/02; A01P 1/00; A01P 3/00

(52) U.S. Cl. CPC A01N 35/02; A01N 25/02; A01P 1/00; A01P 3/00

(57) ABSTRACT

A method for inhibiting growth of oomycete, fungal, or bacterial pathogens while improving crop safety on a plant or plant part is provided. The method includes applying to the plant or plant part or to soil, a composition comprising a C4-C10 α, β-unsaturated aldehyde and a glycol, wherein the composition is applied in an amount of 0.01-5 liters a.i./hectare or 0.01-0.5 liters a.i./1000 kg of produce or plants or plant parts in storage. Compositions comprising a C4-C10 α, β-unsaturated aldehyde and glycols are also provided.

### FIELD OF THE INVENTION

The invention generally relates to compositions containing C4-C10 α, β-unsaturated aldehydes and solvents such as glycols and polymeric surfactants useful for improving crop safety and chemical stability while preventing or inhibiting growth of pathogens on plants.

### BACKGROUND OF THE INVENTION

Plants are subject to multiple potential disease-causing agents, including plant-pathogenic bacteria, fungi and oomycetes.

Bacteria are prokaryotic single-celled microorganisms, generally ranging from 1-2 μm in size that are present on all plant surfaces (epiphytes) and inside plants (endophytes) where they can behave as beneficial or pathogenic to the host. Plant pathogenic bacteria cause many serious diseases of plants throughout the world, and their symptoms range from spots, mosaic patterns or pustules on leaves and fruits, or smelly tuber rots, crown galls to plant death. Most of the plant pathogenic bacteria are either Gram-positive, classified within the Phylum Actinobacteria, or Gram-negative, in the Phylum Proteobacteria.

Fungi are eukaryotic heterotrophic micro-organisms, that can reproduce both sexually and asexually via the production of spores and other structures. Most plant-pathogenic fungi belong to the Ascomycetes and the Basidiomycetes. Spores may be spread long distances by air or water, or they may be soilborne.

Oomycetes are fungus-like organisms. They include some of the most destructive plant pathogens including the genus Phytophthora, which includes the causal agents of potato late blight and sudden oak death. Particular species of oomycetes are responsible for root rot. Although these appear to look like fungi in mycelial growth and nutritional aspects, recent molecular studies have now placed them in Kingdom Chromalveolata and Phylum Heterokontophyta (the “stramenopiles”) along with brown and golden algae and diatoms.

There is an urgent need for safe and effective control measures for bacterial, fungal, and oomycete pathogens.

### SUMMARY

One aspect of the disclosure provides a method for inhibiting growth of oomycete, fungal, or bacterial pathogens on a plant or plant part, comprising applying to the plant, plant loci or plant part a composition comprising one or more C4-C10 alpha beta unsaturated aldehydes and one or more solvents, such as a glycol solvent, wherein the composition is applied in an amount of 0.01-5 liters active ingredient (a.i.)/hectare for in-furrow or foliar application or 0.01-0.5 liters active ingredient/1000 kg of fruit, seeds, vegetables or any plant product. The molar, volumetric, or weight ratio of the one or more C4-C10 alpha beta unsaturated aldehydes to the one or more glycol solvents ranges from 50:50 to 99:1, wherein the moles, volume, or weight of the one or more glycol solvents is sufficient to reduce phytotoxicity of the one or more C4-C10 alpha beta unsaturated aldehydes to the locus of the plant, the plant or the plant part compared to a composition which lacks the one or more glycol solvents.

In some embodiments, the plant or plant part is infected with an oomycete pathogen selected from the group consisting of Phytophthora spp, Peronospora spp, Bremia spp, Albugo spp, Pythium spp, Phytopythium spp, and combinations thereof. In some embodiments, the plant or plant part is infected with a fungal pathogen selected from the group consisting of Alternaria, Aspergillus, Botrytis, Colletotrichum, Ceratocystis, Diplodia, Monilinia, Mycosphaerella, Penicillium, Phomopsis, Puccinia, Rhizopus, Mucor, Sclerotinia, Pseudocercospora, Ustilago and combinations thereof. In some embodiments, the plant or plant part is infected with a bacterial pathogen selected from the group consisting of Xanthomonas, Psuedomonas, Pectobacterium spp., and combinations thereof.

In some embodiments, the composition is applied to the plant or plant part before harvest of the plant or plant part. In some embodiments, the composition is applied via foliar application or a soil application, such as an in-furrow, soil drenching, or seed treatment process. In some embodiments, the composition is applied to the plant or plant part after harvest of the plant or plant part. In some embodiments, the composition is applied to tubers, roots, fruits, vegetables, stems, or seeds. In some embodiments, the plant or plant part comprises potatoes or citrus. In some embodiments, the C4-C10 alpha beta unsaturated aldehyde is selected from the group consisting of trans-2-hexenal, trans-2-octenal, trans-2-pentenal, trans-2-nonenal, trans-2-heptenal, trans-2-decenal, and combinations thereof. In some embodiments, the solvent is a glycol, such as a glycol ether, glycol ester, or glycol amine. In some embodiments, the glycol is selected from the group consisting of propylene glycol, dipropylene glycol, hexylene glycol, ethoxy diglycol, butylene glycol, and combinations thereof. In some embodiments, a ratio of the C4-C10 alpha beta unsaturated aldehyde to the glycol is from 50:50 to 99:1, such as from 75:25 to 95:5.

Another aspect of the disclosure provides a composition, comprising a C4-C10 alpha beta unsaturated aldehyde; and a glycol selected from hexylene glycol and ethoxy diglycol, wherein a ratio of the C4-C10 alpha beta unsaturated aldehyde to the glycol is from 50:50 to 99:1. In some embodiments, the C4-C10 alpha beta unsaturated aldehyde is selected from the group consisting of trans-2-hexenal, trans-2-octenal, trans-2-pentenal, trans-2-nonenal, trans-2-heptenal, trans-2-decenal, and combinations thereof. In some embodiments, the ratio is from 75:25 to 95:5. In some embodiments, the composition further comprises one or more polymeric surfactants.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE DRAWINGS

FIG. 1: Close-up image of lesions/skin damage observed on potato tubers when treated with trans-2-hexenal vapors at 0.15 ml/kg.

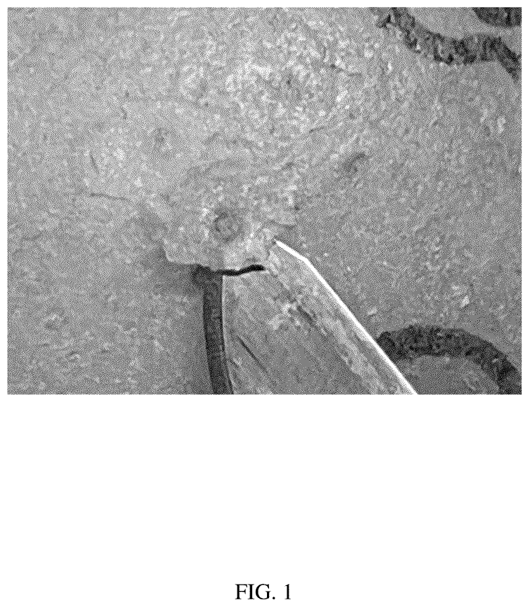

### DETAILED DESCRIPTION

Embodiments of the disclosure provide compositions and methods for inhibiting growth of oomycete, fungal, or bacterial pathogens on a plant loci, plant, or plant part.

“Plant” refers to a multicellular organism in the kingdom Plantae that uses photosynthesis to make its own food. “Plant part” refers to any part of a plant at any time during its life cycle. As used herein, a “plant part” refers to portions of the plant that are above ground or underground. Plant parts include but are not limited to the following, at all stages of development: leaves, stems, canes, buds, flowers, fruits, seeds, nuts, shells, hulls, and roots. “Plant loci” refers to plant parts and the close areas where plant or plant parts occur/reside, e.g. the soil.

Any type of plant or plant part may be treated by a method as disclosed herein including all types of fruits, vegetables, turf, ornamentals (grown in greenhouses such as asters, begonia, carnation, chrysanthemums, cyclamens, gerberas, gladioli, lilies, lisanthus, daisies, violets, poinsettias, ranunculus, tulips, grasses, and hay crops such as fruit trees, vines and bushes and plants that bear berries or vegetables, etc. Plants of any type of orchard, crop, vineyard or garden may be treated. Suitable plants include, but are not limited to, Grass and hay Crop Group (all Crop Groups are as defined by the Environmental Protection Agency) 18: (e.g. alfalfa and clover), Pome fruit Crop Group 11: (e.g. apples pears quince); Crop Group 22 (e.g. asparagus and celery); Globe artichokes, Hops, Root and Tuber vegetables Group: 01: (e.g. ginseng, potato, sweet potato, carrots, sugar beets), Crop Group 24 (e.g. avocado), Brassica spp. Crop Group 05: (e.g. cole crops, broccoli, cabbage, cauliflower), Leafy vegetables Crop Group 04 (e.g. spinach, lettuce, Swiss chard), Citrus Crop Group 10: (e.g. lemons, oranges, mandarins, grapefruit), Cotton, Cucurbit vegetables Crop Group 09: (e.g. cucumber, melons, squash), Fruiting vegetables Crop Group 08: (e.g. tomato, peppers, eggplant), Crop Group 13: (e.g. grapes, blueberries, strawberries and other berries), Herbs and Spices Crop Group 19: (e.g. coriander, dill, fennel, wasabi) Hops, Legume vegetables Crop Group 06: (e.g. beans, peas, lentils, soybeans), Onions and bulb vegetables Crop Group: 03: (e.g. onions, garlic, leeks, chives), Tree nuts Crop Group 14 (e.g. Almonds, pecans, pistachios), Stone Fruits Crop Group 12: (e.g. apricots, nectarines plums), Oilseeds Crop Group 20 (e.g. rapeseed, sunflower), Peanuts, Tobacco, Tropical fruit Crop Group 23: (e.g. papaya, pineapple, mango), Cereal Grains Crop Group 15: (e.g. corn, sorghum rice, wheat), backyard trees (e.g. oaks), banana crops, coffee crops, and nursery stock.

The compositions described herein contain a C4-C10 alpha beta unsaturated aldehyde active ingredient to control the development of oomycete, fungal and bacterial diseases. Suitable C4 to C10 α, β-unsaturated aldehydes for use in the methods of the disclosure are described in U.S. Pat. No. 6,855,669, the complete contents of which are hereby incorporated by reference.

Exemplary aliphatic C4 to C10 aldehydes that may be used in the practice of the invention generally have the chemical formula:

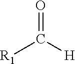

where R₁ is a C3 to C9 branched or unbranched, substituted or unsubstituted saturated alkyl or a C3 to C9 branched or unbranched, substituted or unsubstituted unsaturated alkenyl.

In some embodiments, the C4-C10 alpha beta unsaturated aldehyde is selected from the group consisting of trans-2-hexenal, trans-2-octenal, trans-2-pentenal, trans-2-nonenal, trans-2-heptenal, trans-2-decenal, and combinations thereof.

By “substituted” it is meant that there is a replacement of one or more hydrogens with a monovalent or divalent radical. Suitable substitution groups include but are not limited to, for example, hydroxyl, nitro, amino, imino, cyano, halo, thio, thioamido, amidino, imidino, oxo, oxamidino, methoxamidino, guanidino, sulfonamido, carboxyl, formyl, lower alkyl, halo-lower alkyl, lower alkoxy, halo-lower alkoxy, lower alkoxyalkyl, alkylcarbonyl, cycloalkyl, heterocycloalkyl, alkylthio, aminoalkyl, cyanoalkyl, and the like.

Application of the C4-C10 α, β-unsaturated aldehyde controls pathogens but the chemical can also cause crop damage (phytotoxicity), e.g. by damaging sprayed leaves (foliage), stems, fruits or post-harvest fruits (including nuts, berries and the like), seeds, flowers, tubers, bulbs and vegetables. Embodiments provide the combination of the aldehyde with at least one solvent, such as an organic solvent, which reduces the phytotoxicity of the aldehyde. An exemplary solvent is a glycol solvent. A glycol an organic alcohol compound with two-OH groups which are attached to two different carbon atoms. In some embodiments, the glycol is a glycol ether, glycol ester, or glycol amine. In some embodiments, the glycol is selected from the group consisting of propylene glycol, dipropylene glycol, hexylene glycol, ethoxy diglycol, butylene glycol, and combinations thereof. In some embodiments, a ratio of 20 the C4-C10 alpha beta unsaturated aldehyde to the glycol is from 50:50 to 99:1, such as from 75:25 to 95:5, or most preferred 90:10. The glycol may be administered simultaneously or sequentially, i.e. before or after, the aldehyde. In some embodiments, the glycol is present in the same formulation as the aldehyde. In some embodiments, the aldehyde is present in an amount of 80-99 wt %. In some embodiments, the solvent is present in an amount of 1-10 wt %.

The composition may further comprise one or more polymeric surfactants. Polymeric surfactants are surfactant molecules that have a polymeric backbone, which can be made up of various repeating units. These surfactants have both hydrophilic and hydrophobic segments. Suitable surfactants include, but are not limited to, polyethylene glycol (PEG), polyvinyl alcohol (PVA), polyvinyl pyrrolidone (PVP), and polyacrylamide (PAM) based surfactants. In some embodiments, the surfactants are present in an amount of 1-10 wt %.

The vapor pressure of trans-2-hexenal is relatively high (13 hpa at 20° C.) and therefore will not linger on leaf surfaces and vaporize quickly. An adjuvant may be used to help penetrate the leaf through translaminar activity in sufficient quantity to the kill fungal pathogens but low enough as to not cause leaf phytotoxicity. Without being bound by theory, since glycols have lower vapor pressures (propylene glycol is 10.6 pa at 20° C.), the combination allows trans-2-hexenal to both spread and penetrate the leaf tissue at lower rates than otherwise required hence effectively reducing the risk of leaf phytotoxicity.

In some embodiments, the composition further comprises an adjuvant which refers to any compound which enhances the penetration of the compounds described herein or assists with the spread of the same on top of the plant or plant part. Examples of suitable adjuvants include but are not limited to various surfactants, oils and other inorganic and organic compounds, e.g. Hasten®, Agridex®, various organosilicone adjuvants (e.g. Pulse®), various non-ionic wetting agents) polymeric surfactants (e.g., Makon® DA-9), other surfactants (e.g., Papi™-27) etc.

The compositions described herein may be used to prevent growth, inhibit growth or destroy the growth of any oomycete, bacterial, or fungal pathogens.

The stramenopiles (or oomycetes) contain three families of plant pathogens. The family Peronosporaceae (downy mildews) attack a wide range of crops including grapes, broccoli, onions, cucurbits, sorghum and lettuce. Other families include Pythium spp. (damping off) and Phytophthora spp. (late blights), foliar blights on peppers and cucurbits, root or stem rots of many plant species. Certain trees in forests (e.g. oaks) and nurseries are also susceptible to blights as well. Another family (Albuginaceae) contain organisms (Albugo spp.) responsible for causing white rust (not a true fungal “rust”) on stems, leaves and fruits on cruciferous plants such as radish, horseradish and many weed species.

These oomycetes differ from true fungi in several physical attributes: oomycete cell walls contain cellulose, beta glucans and the amino acid hyroxyproline, but do not contain chitin which occurs in the cell walls of true fungi. The vegetative state of oomycetes is diploid, whereas true fungi are haploid or dikaryotic. Oomycetes also produce hyphae which are non-septate (lacking cross-walls). Among most of the soil and water inhabiting oomycete genera the sporangia germinate indirectly by producing motile zoospores (asexual spores) which propel themselves by means of two dissimilar flagella in soil and water media. In both heterothallic and homothallic oomycetes, the fertilization results in a thick-walled zygote called an oospore (resting spores), which is also unique to the oomycetes. Nevertheless, oomycetes may be considered as a type of fungi.

In some embodiments, the oomycete pathogen to be treated is selected from downy mildews, blue molds (Peronospora spp., Bremia spp.); white rusts (Albugo spp.), damping off, cavity spot, root die back, pythium leak, pod rot, (various Pythium spp. such as Pythium ultimum var. ultimum, Pythium debaryanum, Pythium aphanidermatum, and Pythium deliense), root rots, crown rots, citrus fruit rots, collar rots, fruit rots, gummosis, heart rots, leather rots, red stele, stem rots, spear rots, trunk rots, pink rot, black shank, vascular collapse (various Phytophthora spp., e.g. Phytophthora infestans, Phytophthora cryptogea, Phytophthora drechsleri, Phytophthora erythroseptica, Phytophthora megasperma, Phytophthora nicotianae var. parasitica), etc. In some embodiments, the oomycete pathogen is selected from the group consisting of Phytophthora spp., Peronospora spp., Bremia spp., Albugo spp., Pythium spp., and combinations thereof.

Plant pathogenic bacteria cause many serious diseases of plants throughout the world, and their symptoms range from spots, mosaic patterns or pustules on leaves and fruits, or smelly tuber rots, crown galls to plant death. Most of the plant pathogenic bacteria are either Gram-positive, classified within the Phylum Actinobacteria, or Gram-negative, in the Phylum Proteobacteria. Bacterial diseases that can be addressed or treated as described herein include but are not limited to: Bacterial wilt (brown rot) caused by Ralstonia solanacearum (Pseudomonas solanacearum); Blackleg and bacterial soft rot caused by Pectobacterium carotovorum subsp. atrosepticum, Erwinia carotovora subsp. atroseptica, Pectobacterium carotovorum subsp. carotovorum, E. carotovora subsp. carotovora, Pectobacterium chrysanthemi, E. chrysanthemi; Pink eye caused by Pseudomonas fluorescens; Ring rot caused by Clavibacter michiganensis subsp. Sepedonicus, Corynebacterium sepedonicum; Common scab caused by Streptomyces scabiei, S. scabies, Streptomyces acidiscabies, Streptomyces turgidiscabies); etc. In some embodiments, the plant or plant part is infected with a bacterial pathogen selected from the group consisting of Xanthomonas, Psuedomonas, Pectobacterium spp., and combinations thereof.

Most plant-pathogenic fungi belong to the Ascomycetes and the Basidiomycetes. Fungal diseases include, but are not limited to: Black dot (Colletotrichum coccodes, Colletotrichum atramentarium), Brown spot and Black pit (Alternaria alternate, Alternaria tenuis), Cercospora leaf blotch (Mycovellosiella concors, Cercospora concors, Cercospora solani, Cercospora solani-tuberosi), Charcoal rot (Macrophomina phaseolina, Sclerotium bataticola), Choanephora blight (Choanephora cucurbitarum), Common rust (Puccinia pittieriana), Deforming rust (Aecidium cantensis), Early blight (Alternaria solani), Fusarium dry rot (Fusarium spp. Gibberella pulicaris, Fusarium solani; Other Fusarium spp. include: Fusarium avenaceum, Fusarium oxysporum, Fusarium culmorum; less common Fusarium spp. include: Fusarium acuminatum, Fusarium equiseti, Fusarium crookwellense), Fusarium wilt (Fusarium spp. Fusarium avenaceum, Fusarium oxysporum, Fusarium solani f.sp. eumartii), Gangrene (Phoma solanicola f. foveata, Phoma foveata, Phoma exigua var. foveata, Phoma exigua f. sp. Foveata, Phoma exigua var. exigua), Gray mold (Botrytis cinerea, Botryotinia fuckeliana [teleomorph]), Phoma leaf spot (Phoma andigena var. andina), Powdery mildew (Erysiphe cichoracearum), Powdery scab (Spongospora subterranea f.sp. subterranean), Rhizoctonia canker and black scurf (Rhizoctonia solani, Thanatephorus cucumeris [teleomorph]), Rosellinia black rot (Rosellinia sp. Dematophora sp. [anamorph]), Septoria leaf spot (Septoria lycopersici var. malagutii), Sigatoka (Mycosphaerella fijiensis), Silver scurf (Helminthosporium solani), Skin spot (Polyscytalum pustulans), Stem rot (southern blight) (Sclerotium rolfsii, Athelia rolfsii [teleomorph]), Thecaphora smut (Angiosorus solani, Thecaphora solani), Ulocladium blight (Ulocladium atrum), Verticillium wilt (Verticillium albo-atrum, Verticillium dahlia), Wart (Synchytrium endobioticum), and White mold (Sclerotinia sclerotiorum), etc. In some embodiments, the plant or plant part is infected with a fungal pathogen selected from the group consisting of Alternaria, Aspergillus, Botrytis, Colletotrichum, Diplodia, Monilinia, Penicillium, Phomopsis, Rhizopus, Mucor, Sclerotinia, and combinations thereof.

In some embodiments, the oomycete, fungal, or bacterial pathogen has developed resistance to another anti-oomycete, anti-fungal, or anti-bacterial agent. For example, the pathogen may be resistant to one or more of oomycete controlling fungicides such as cyazofamid, cymoxanil, ethaboxam, fenamidone, fluopicolide, metalaxyl, mefenoxam, dimethomorph, mandipropamid, oxathiapiprolin, zoxamide etc. The compositions described herein may be used in combination with any other anti-oomycete, anti-fungal, or anti-bacterial agent to enhance susceptibility to such agents as part of a disease resistance management program.

The methods of treating plants or plant parts described herein may include a step of identifying plants or plant parts that can benefit from such treatment, e.g. by identifying disease symptoms on the plant or plant part. The treatment may occur before or after harvesting, e.g. to a plant or plant part that is in storage prior to planting in the field, distribution to stores or consumers, and to those that have been distributed (made available) to an end user, e.g. a restaurant, a processing facility (e.g. canning, frozen food, juice, etc. facility), or an individual consumer. In particular, the plant or plant part may already exhibit one or more undesirable characteristics such as breach or damage of the exterior/skin, appearance of mildew, blisters, necrosis, loss of turgidity and firmness, and/or other evidence of disease, such as disease discoloration on the exterior or interior of the plant or plant part. If applied pre-harvest (seed treatments, foliar or in-furrow), the composition may be applied in an amount of 0.01-15 liters/hectare, e.g. 0.01-5 liters/hectare. If applied post-harvest, the composition may be applied in an amount of 0.01-5 liters a.i./1000 kg of fruits, seeds, vegetables, tubers etc., e.g. 0.01-0.5 liters a.i./1000 kg of produce or other plant parts.

The compositions may be applied by any suitable technique. Examples include but are not limited to: foliar application by spraying (e.g. by electrostatic spraying, drone applications, air blast or mist sprayers and the like), fogging in greenhouses or cold storage or controlled atmosphere (CA) buildings (e.g. by hot or cold fogging machines), misting or via a ventilation or humidification system; or a soil application, such as by applying an in-furrow (e.g. just before or at planting seed or seed pieces), soil drenching of soil or soil less media (e.g. in field or greenhouse), or seed treatment process; or another suitable technique such as by dipping, coating, or deposition or release from slow-release matrices (e.g., granules impregnated with such mixtures) which may be added to or incorporated in plastic, paper, or box materials used to store the plant or plant part. Any suitable application technique may be used, preferably so long as a uniform or relatively uniform coating of the composition is applied. In some embodiments, the compounds may be mixed with various other agents known to facilitate the delivery of gases, liquids, or gels as appropriate (e.g. emulsifiers, slow-release agents or encapsulation matrices microbeads and the like). In some embodiments, the composition is applied to leaves, tubers, roots, fruits (including nuts, berries and the like), vegetables, stems, and/or seeds. The applications can be made a single time or multiple times over the course of one or several seasons.

The composition may be made at any time of plant development, e.g. from seedling emergence, transplanting time (seedling dips) to flowering, fruiting through crop maturity, harvest and post-harvest time.

The compositions described herein are used to prevent, reduce, inhibit, control or treat pathogen-related diseases as described herein. Even though C4-C10 alpha-beta unsaturated aldehydes exhibit fungicidal properties, the lack of crop safety (i.e., damage to plant fruit, leaves, seeds, stems etc.) dramatically reduces the usefulness of these compounds. Our unexpected discovery relating to the mixing of solvents such as glycols with or without polymeric surfactants, can dramatically reduce the risk of plant damage and increase the usefulness of C4-C10 alpha-beta unsaturated aldehydes for preventing or controlling plant diseases safely. Disease symptoms may be prevented altogether, or be delayed, or slowed or eradicated completely when compared to untreated plants or plant parts. In any case, the disease development is inhibited or slowed by treating the plant or plant part with the compositions as described herein, in comparison to plants or plant parts that are not exposed to or contacted by the compositions in a similar manner. In some cases, symptoms of disease, are completely prevented (prophylactically) before symptoms occur, or are reversed or eradicated, if symptoms are already present before application. The decrease will be in the range of at least about 10 to 100%, preferably in the range of about 50 to 100%, and most preferably in the range of about 75 to 100%. The beneficial effects generally last between 14 and 100 days and in some cases, as much as six months (e.g., in cold storage) depending on the conditions. Those of skill in the art will recognize that the results can also be highly beneficial even if some symptoms remain(s) or eventually develop(s), i.e. even if the progress of the development of unwanted characteristics is arrested (but not reversed), slowed, decreased, lessened, or delayed, or if the amount or extent of damage is decreased, but not completely eliminated.

The molar/volumetric/weight ratio of the one or more C4-C10 alpha beta unsaturated aldehydes to the one or more glycol solvents ranges from 50:50 to 99:1, wherein the moles/volume/weight of the one or more glycol solvents is sufficient to reduce phytotoxicity of the one or more C4-C10 alpha beta unsaturated aldehydes to the locus of the plant, the plant or the plant part compared to a composition which lacks the one or more glycol solvents. Phytotoxicity may be characterized broadly as plant injury and may manifest or express itself in a number of ways including subtle and/or obvious symptoms. For example, symptoms may include compromised physical and/or physiological activity or function of one or more aspects of a plant and may range from minor leaf speckling to plant death. Phytotoxicity symptoms may include, but are not limited to, chlorosis, necrosis, burning, leaf speckling or banding, leaf drop, fruit spotting, distortion of new growth, stunting of growth, cessation of growth, discoloration (e.g., yellowing of the leaves (soaps)), root injury (e.g., poor root development or growth), puckering (xylene injury), tip browning, plant death, and the like. For example, phytotoxicity may result in a reduction or compromise in a plant's metabolic activity, such as manifested as adversely affecting (e.g., stunting) plant growth, e.g., phytotoxicity may be observed as an adverse effect on a plant's overall vigor and growth.

For additional chemical stability in the formulation, it has been discovered, unexpectedly, that the use of a polymeric surfactant class mixed with a glycol solvent is advantageous. Chemical stability enables the use of such formulations and allows for the use of the fungicide (C4-C10 alpha-beta unsaturated aldehydes) for an extended period of time ranging from months to years without dissipation of the a.i.

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited.

The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLES

### Example 1. Efficacy of Trans-2-Hexenal Specially Formulated for Controlling Oomycete Pathogens

Two unique sprayable formulations containing 16.8% trans-2-hexenal (specially formulated with ethylene glycol among the adjuvants) and 21.0% trans-2-hexenal (specially formulated with adjuvants containing a polymeric surfactant and propylene glycol), respectively were prepared, identified herein as TRANS-2-HEXENAL-A and TRANS-2-HEXENAL-B. A good response against different oomycete pathogens was obtained for both formulations ranging from 10 g (11.8 mL) active ingredient (a.i.) per acre to 1000 g (1183 mL) a.i. per acre. Chlororthalonil was used as a standard for control of late blight of potato (Phytophthora infestans).

Table 1 shows the efficacy of TRANS-2-HEXENAL-A and TRANS-2-HEXENAL-B for controlling late blight in potato. All treatments were replicated 4 times and set up in a randomized complete block design. Potato plants were treated weekly for 6 weeks after the disease was first detected in Thonotosassa, FL. Note: Both 1000 g ai/ac treatments showed severe phytotoxicity (leaf burn) after 2-3 applications whereas the 10 g and 100 g/acre treatments did not exhibit any phytotoxicity symptoms. All trans-2-hexenal-A treatments and chlorothalonil decreased overall disease infestation over time. No skin or pitting damage (lesions) to the potato tubers was observed. (AUDPC=Area Under the Disease Progression Curve).

TABLE 1

| | AUDPC % - P. infestans |
|---|---|
| Treatments | Disease Severity |
| Control | 15.35 |
| TRANS-2-HEXENAL-A at 10 g ai/A | 6.99 |
| TRANS-2-HEXENAL-A at 100 g ai/A | 4.00 |
| TRANS-2-HEXENAL-A at 1000 g ai/A | 3.46 |
| TRANS-2-HEXENAL-B at 10 g ai/A | 8.25 |
| TRANS-2-HEXENAL-B at 100 g ai/A | 5.67 |
| TRANS-2-HEXENAL-B at 1000 g ai/A | 2.52 |
| Equus (chlorothalonil fungicide) 720 SST | 5.39 |
| 473 mL/A | |

Table 2 shows TRANS-2-HEXENAL-A was effective for controlling Pythium ultimum disease and for also increasing marketable potato yields. All treatments were replicated 4 times and set up in a randomized complete block design in Idaho. All rates provided the highest total marketable yields-however, TRANS-2-HEXENAL-A when treated at 250 g/acre, the potato yields were slightly lower. No lesions or skin damage to the potatoes was observed.

TABLE 2

| | | | Total |
|---|---|---|---|
| | P. ultimum | P. ultimum | Marketable |
| | Pest | Pest | Potato Yield |
| | Incidence | Severity | (cwt) |
| Treatments | (%) | (%) | (cwt = 100 lbs) |
| Untreated Control | 50.8 | 15.8 | 124.9 |
| Ridomil (mefenoxam) fb Resist (phosphorus | 53.5 | 9.3 | 109.0 |
| acid (×3 apps) | | | |
| TRANS-2-HEXENAL-A 10 g/ac (×3 apps*) | 27.5 | 10.0 | 163.6 |
| TRANS-2-HEXENAL-A 50 g/ac (×3 apps) | 26.8 | 11.5 | 168.6 |
| TRANS-2-HEXENAL-A 100 g/ac (×3 apps) | 25.8 | 12.5 | 162.2 |
| TRANS-2-HEXENAL-A 250 g/ac (×3 apps) | 20.0 | 8.8 | 131.1 |

*All applications (apps) were made to potato plants three times, 14 days apart post flowering

Table 3 shows that TRANS-2-HEXENAL-A was effective for controlling pink rot Phytophthora erythroseptica in potatoes. All treatments were replicated 4 times and set up in a randomized complete block design in Idaho. Potato plants were treated weekly for 3 weeks after the disease was first detected in TRANS-2-HEXENAL-A at 50 g/acre gave the highest yields. No lesions or skin damage to the potato tubers was observed.

TABLE 3

| | P. | P. | Potato |
|---|---|---|---|
| | erythroseptica | erythroseptica | Yield |
| | Pest Incidence | Pest Severity | (cwt) per |
| Treatments | (%) | (%) | Acre |
| Untreated control | 73.5 | 33.0 | 64.5 |
| TRANS-2-HEXENAL-A 10 g/ac (×3 apps*) | 23.3 | 13.5 | 152.0 |
| TRANS-2-HEXENAL-A 50 g/ac (×3 apps) | 31.8 | 11.5 | 157.1 |
| TRANS-2-HEXENAL-A 100 g/ac (×3 apps) | 31.0 | 15.3 | 125.1 |
| TRANS-2-HEXENAL-A 250 g/ac (×3 apps) | 26.0 | 14.3 | 98.9 |

*All applications (apps) were made to potato plants, 14 days apart post flowering

Example 2. Evaluation of glycols as agents to reduce skin damage or lesions which is often observed with trans-2-hexenal treatments in a dose dependent manner. The overall objective was to prevent lesions/skin damage of trans-2-hexenal to tubers in storage when used for disease control.

Bulk Yukon Gold (a yellow potato variety), Norland Red (a red potato variety), both possess thin skins and are susceptible to skin damage. Ranger Russet table potatoes were also obtained fresh, and all tubers were stored at 6.5° C. Yukon Gold, Norland Red, and Ranger Russet tubers were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of trans-2-hexenal with or without propylene glycol (or other glycols) was applied to the filter paper. Quickly thereafter, a heat gun equipped with temperature control set at a low blower speed, was used to heat the T2H/glycol mixture-loaded filter paper, causing the vapors to evaporate into the glass jar with the potato tubers. The heat gun was set at 350-550° F. (177-288° C.) on low blower speed setting and directed for 30-60 sec depending on the glycol mixture used.

After each treatment, the filter paper was checked for wetness and smell, and when the paper was dry to the touch and lacked the T2H odor, it was considered evidence that there was no trans-2-hexenal left on the filter paper. Soon after treatment, the assembly (with the filter paper lids) was removed and replaced with a normal Mason jar lid and screwed tight. The jars were placed horizontally in a cool, dark place (22.8° C.) and tubers were taken out after 48 and 96 hours and evaluated for skin lesions/skin damage using a 6× magnification head loupe. The results for this test with two rates of T2H are shown in Table 4.

TABLE 4

| | | | No. of | |
|---|---|---|---|---|
| Treatment | | No. of | Fresh | Total |
| (n = 5 Tubers/ | | Lesions | Lesions | Lesions/ |
| variety) | Variety | (48 h) | (96 h) | tuber |
| T2H 0.5 mL/kg | Yukon Gold | 10 | 15 | 25 |
| T2H 0.5 mL/kg | Norland Red | 3.5 | 13 | 16.5 |
| T2H 0.5 mL/kg | Ranger Russet | 4 | 6 | 10 |
| T2H 1.0 mL/kg | Yukon Gold | 6 | 10 | 16 |
| T2H 1.0 mL/kg | Norland Red | 16 | 38 | 54 |
| T2H 1.0 mL/kg | Ranger Russet | 3 | 23 | 26 |

Next, a trans-2-hexenal (T2H) and propylene glycol (PG) mixture (50:50 v/v) was prepared then evaluated for reduction of skin damage to potato tubers. Potato varieties, Yukon Gold and Norland Red were used for this evaluation. For the next series of experiments, to the same set up described above, a 20-inch Tygon tubing was inserted into the bottom of the Mason jar containing both varieties of potatoes (n=5/variety) and pulled through the treatment lid assembly. At the other end of the tubing, a plastic funnel (9.5 cm dia) was taped and the funnel was placed over the air intake slots of the heat gun. This assembly ensured the vapor would recirculate from the bottom of the jar through the heat gun assembly during treatment. After completion of the heat treatment, the filter paper was dry to the touch for all the treatments which indicated that all the T2H and/or PG was vaporized into the Mason jar. The PG mixture treatments took the longest (60 sec). Counts were made at 48 h and 96 h by marking the lesions (each measuring 0.05 to >0.1 mm) on the potato tuber with the aid of a 6× magnification head loupe. A cluster of very small lesions in an area less than 2 mm was counted as one lesion. The results are shown in Table 5.

TABLE 5

| | | No. of | Fresh | TOTAL |
|---|---|---|---|---|
| | | Lesions/ | Lesions/ | No. of |
| Treatment | | 5 Tubers | 5 Tubers | Lesions/ |
| (n = 5 tubers/treatment) | Variety | (48 h) | (96 h) | 5 Tubers |
| T2H alone (0.27 ml/kg) | Yukon Gold | 24 | 32 | 56 |
| T2H (0.27 ml/kg) + PG (0.27 ml/kg) | Yukon Gold | 19 | 30 | 49 |
| (50:50 v/v) | | | | |
| Control--PG alone 0.27 ml/kg | Yukon Gold | 5 | 10 | 15 |
| T2H 0.27 ml/kg | Norland Red | 32 | 40 | 72 |
| T2H (0.27 ml/kg) + PG (0.27 ml/kg) | Norland Red | 20 | 28 | 48 |
| (50:50 v/v) | | | | |
| Control - PG alone (0.27 ml/kg) | Norland Red | 10 | 13 | 23 |

The same experiment was repeated, and the results are shown in Table 6.

TABLE 6

| | | Total | Total | |
|---|---|---|---|---|
| | | Number of | Number of | TOTAL |
| Treatment | | Lesions/ | Lesions/ | No. of |
| (n = 5 tubers/ | | 5 Tubers | 5 Tubers | Lesions/ |
| treatment) | Variety | (48 h) | (96 h) | 5 Tubers |
| T2H alone | Yukon | 33 | 25 | 58 |
| (0.27 mL/kg) | Gold | | | |
| T2H alone | Norland | 26 | 29 | 55 |
| (0.27 mL/kg) | Red | | | |
| T2H (0.27 mL/kg) + | Yukon | 18 | 21 | 39 |
| PG (0.27 mL/kg) | Gold | | | |
| (50:50 v/v) | | | | |
| T2H (0.27 mL/kg) + | Norland | 23 | 31 | 54 |
| PG (0.27 mL/kg) | Red | | | |
| (50:50 v/v) | | | | |
| Control --PG alone | Yukon | 15 | 9 | 24 |
| (0.27 mL/kg) | Gold | | | |
| Control --PG alone | Norland | 14 | 3 | 17 |
| (0.27 mL/kg) | Red | | | |

This experiment was repeated with the same experimental conditions described above but with a reduced dose of T2H (0.10 mL/kg instead of 0.27 mL/kg) and mixed with PG at a ratio 50:50 (v/v) and 75:25 (v/v) respectively. The results are shown in Table 7.

TABLE 7

| | | Total Number of | | |
|---|---|---|---|---|
| Treatment | | Lesions/5 Tubers | | |
| (n = 5 tubers/treatment) | Variety | 48 h | 96 h | TOTAL |
| T2H alone (0.10 mL/kg) | Yukon | 16 | 23 | 39 |
| | Gold | | | |
| T2H alone (0.10 mL/kg) | Norland | 9 | 16 | 25 |
| | Red | | | |
| T2H (0.10 mL/kg) + PG | Yukon | 9 | 25 | 34 |
| (0.10 mL/kg) (50:50 v/v) | Gold | | | |
| T2H (0.10 mL/kg) + PG | Norland | 5 | 7 | 12 |
| (0.10 mL/kg) (50:50 v/v) | Red | | | |
| T2H (0.10 mL/kg) + PG | Yukon | 8 | 17 | 25 |
| (0.033 mL/kg) (75:25 v/v) | Gold | | | |
| T2H (0.10 mL/kg) + PG | Norland | 9 | 9 | 18 |
| (0.033 mL/kg) (75:25 v/v) | Red | | | |
| Control -PG alone (0.10 mL/kg) | Yukon | 6 | 2 | 8 |
| | Gold | | | |
| Control -PG alone (0.10 mL/kg) | Norland | 5 | 3 | 8 |
| | Red | | | |
| Water Control (0.10 mL/kg) | Yukon | 5 | 3 | 8 |
| | Gold | | | |
| Water Control (0.1 mL/kg) | Norland | 2 | 1 | 3 |
| | Red | | | |

This experiment was again repeated with different varieties of potatoes (Isabella and Cecile) and but at a higher rate of T2H (0.15 mL/kg vs 0.10 mL/kg). The level of T2H was held constant at 0.15 mL/kg in all solo and mixture treatments. The results are shown in Table 8.

TABLE 8

| | | Total No. | | |
|---|---|---|---|---|
| Treatment | | of Lesions | | |
| (n = 5 tubers/treatment) | Variety | 48 h | 96 h | TOTAL |
| Control -PG alone (0.45 ml/kg) | Isabella | 12 | 19 | 31 |
| Control -PG alone (0.45 ml/kg) | Cecile | 15 | 11 | 26 |
| T2H alone (0.15 mL/kg) | Isabella | 43 | 37 | 80 |
| T2H alone (0.15 mL/kg) | Cecile | 74 | 58 | 132 |
| T2H (0.15 mL/kg) + PG | Isabella | 10 | 23 | 33 |
| (0.45 mL/kg) (25:75 v/v) | | | | |
| T2H (0.15 mL/kg) + PG | Cecile | 15 | 26 | 41 |
| (0.45 mL/kg) (25:75 v/v) | | | | |
| T2H (0.15 mL/kg) + PG | Isabella | 10 | 18 | 28 |
| (0.15 ml/kg) (50:50 v/v) | | | | |
| T2H (0.15 mL/kg) + PG | Cecile | 26 | 37 | 63 |
| (0.15 mL/kg) (50:50 v/v) | | | | |
| T2H (0.15 mL/kg) + PG | Isabella | 12 | 15 | 27 |
| (0.05 mL/kg) (75:25 v/v) | | | | |
| T2H (0.15 mL/kg) + PG | Cecile | 22 | 39 | 61 |
| (0.05 mL/kg) (75:25 v/v) | | | | |
| T2H (0.15 mL/kg) + PG | Isabella | 9 | 14 | 23 |
| (0.015 mL/kg) (90:10 v/v) | | | | |
| T2H (0.15 mL/kg) + PG | Cecile | 14 | 30 | 44 |
| (0.017 mL/kg) (90:10 v/v) | | | | |

Various trans-2-hexenal (T2H) and a second glycol—hexylene glycol (HG) mixtures at different ratios, were also evaluated for reduction of skin damage to potato tubers using the same experimental set up as described above. As before, Isabella (yellow) and Cecile (red) potatoes were obtained fresh from storage. The HG solo/mixture treatments took the longest to vaporize with a heat gun because HG was viscous and did not vaporize readily. The filter paper was dry for all the treatments listed below. As before, the level of T2H was kept constant at 0.15 mL/kg in all solo and mixture treatments. Counts were made by marking the lesions (0.1 to >0.5 mm) on the tuber skins with the aid of a 6× magnification head loupe after 48 and 96 h. A cluster of very small lesions in an area less than 2 mm was counted as one lesion. The results are shown in Table 9.

TABLE 9

| | | Total No. | | |
|---|---|---|---|---|
| | | of Lesions | | |
| Treatment (n = 5 tubers/treatment) | Variety | 48 h | 96 h | TOTAL |
| Control -HG alone (0.45 ml/kg) | Isabella | 9 | 1 | 10 |
| Control -HG alone (0.45 ml/kg) | Cecile | 10 | 6 | 16 |
| T2H alone (0.15 mL/kg) | Isabella | 31 | 12 | 43 |
| T2H alone (0.15 mL/kg) | Cecile | 23 | 21 | 44 |
| T2H (0.15 ml/kg) + HG (0.45 mL/kg) (25:75 v/v) | Isabella | 23 | 30 | 53 |
| T2H (0.15 ml/kg) + HG (0.45 mL/kg) (25:75 v/v) | Cecile | 30 | 30 | 60 |
| T2H (0.15 ml/kg) + HG (0.15 mL/kg) (50:50 v/v) | Isabella | 16 | 13 | 29 |
| T2H (0.15 ml/kg) + HG (0.15 mL/kg) (50:50 v/v) | Cecile | 22 | 14 | 36 |
| T2H (0.15 mL/kg) + HG (0.05 mL/kg) (75:25 v/v) | Isabella | 13 | 17 | 30 |
| T2H (0.15 mL/kg) + HG (0.05 mL/kg) (75:25 v/v) | Cecile | 16 | 14 | 30 |
| T2H (0.15 mL/kg) + HG (0.017 mL/kg) (90:10 v/v) | Isabella | 9 | 10 | 19 |
| T2H (0.15 mL/kg) + HG (0.017 mL/kg) (90:10 v/v) | Cecile | 11 | 12 | 23 |

Various trans-2-hexenal (T2H) and a third glycol-ethoxy diglycol (EDG) mixtures were further evaluated for reduction of skin damage to potato tubers. Cecile (red) potatoes freshly dug up from a potato field and allowed to suberize for 10 days prior to treatment at 6.5° C. The EDG solo/mixture treatments took the longest (60 sec) to vaporize. The filter paper was dry to the touch for all the treatments listed below which indicated that the impregnated quantity vaporized into the Mason jar. The level of T2H was held constant at 0.15 mL/kg in all solo and mixture treatments. Counts were made by marking the lesions (0.10 to >0.5 mm) with the aid of a 6× magnification head loupe after 48 h and 96 h. A cluster of very small lesions in an area less than 2 mm was counted as one lesion. The results are shown in Table 10.

TABLE 10

| | | Total | Total | |
|---|---|---|---|---|
| | | No. of | No. of | |
| Treatment | | Lesions | Lesions | |
| (n = 5 tubers/treatment) | Variety | (48 h) | (96 h) | TOTAL |
| Control -EDG alone (0.45 ml/kg) | Cecile | 3 | 11 | 14 |
| T2H alone (0.15 mL/kg) | Cecile | 12 | 37 | 49 |
| T2H (0.15 mL/kg) + EDG | Cecile | 6 | 15 | 21 |
| (0.45 mL/kg) (25:75 v/v) | | | | |
| T2H (0.15 mL/kg) + EDG | Cecile | 7 | 14 | 21 |
| (0.15 mL/kg) (50:50 v/v) | | | | |
| T2H (0.15 mL/kg) + EDG | Cecile | 4 | 15 | 19 |
| (0.05 mL/kg) (75:25 v/v) | | | | |
| T2H (0.15 mL/kg) + EDG | Cecile | 2 | 13 | 15 |
| (0.017 mL/kg) (90:10 v/v) | | | | |

All the experiments clearly showed that when different rates of T2H were mixed in any ratio with any glycol, on any variety of potato, unexpectedly, there was substantial reduction of pitting/lesion damage to the tubers. The skin pitting/lesion damage to potatoes when T2H was applied alone has already been reported elsewhere by Knowles et al. 2005 (U.S. Pat. No. 6,855,669 incorporated herein by reference, Table 2).

### Example 3. Evaluation of Trans-2-Hexenal (T2H) and T2H Mixture with Propylene Glycol (PG) for Reducing Phytotoxicity on Mandarin Oranges

Fresh mandarin oranges were obtained from supermarket and blemish free samples were used for treatments. Treatment was made when the oranges were at room temperature. The oranges were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of trans-2-hexenal with or without propylene glycol (or other glycols) was applied to the filter paper. Quickly thereafter, a heat gun equipped with temperature control set at a low blower speed, was used to heat the T2H/glycol mixture-loaded filter paper, causing the vapors to evaporate into the glass jar with the oranges. The heat gun was set at 350-550° F. (177-288° C.) on low blower speed setting and directed for 30-60 sec depending on the glycol mixture used. Controls were treated with the max. rate of PG (0.025 mL/kg).

After each treatment, the filter paper was checked for wetness and smell, and when the paper was dry to the touch and lacked the T2H odor, it was considered evidence that there was no trans-2-hexenal left on the filter paper. Soon after treatment, the assembly (with the filter paper lids) was removed and replaced with a normal Mason jar lid and screwed tight. The jars were placed horizontally in a cool, dark place (22.8° C.) and oranges were taken out and evaluated for peel scarring. The results for this test are shown in Table 11.

TABLE 11

| | Cumulative Peel | Post Treatment Mandarin |
|---|---|---|
| Treatment (N = 5) | Scarring (N = 5) | Visual Fruit Quality |
| Control - Propylene glycol | 3 | Minor discoloration/spotting of peel. |
| (PG) only at 0.025 mL/kg | | Fruit quality marginally acceptable 5/5 |
| | | fruits |
| Trans-2-hexenal (T2H) at | 320 | 75%-90% fruit peel turned reddish |
| 0.500 mL/kg | | brown - Unacceptable scars (5/5 fruits) |
| Trans-2-hexenal (T2H) at | 13 | Reddish brown spotting - unacceptable |
| 0.250 mL/kg | | scarring (5/5 fruits) |
| Trans-2-hexenal (T2H) at | 3 | Peel quality was good--acceptable (4//5 |
| 0.25 mL + 0.025 mL PG | | fruits) |
| (10:1) | | |

A dose rate of trans-2-hexenal at 0.5 or 0.25 mL/kg when applied as a vapor to mandarin oranges was phytotoxic to the peels. Addition of Propylene glycol at a 10:1 ratio substantially reduced peel damage. Thus, the mixture with propylene glycol reduced the phytotoxicity of trans-2-hexenal.

Example 4. Evaluation of Trans-2-hexenal (T2H), Trans-2-pentenal (T2P), Trans-2-heptenal (T2Heptenal), and Trans-2-Decenal (T2D) for Phytotoxicity on Yukon Gold Potatoes. A dose response study.

The potatoes were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of aldehyde was applied to the filter paper. Quickly thereafter, a heat gun equipped with temperature control set at a low blower speed, was used to heat the aldehyde-loaded filter paper, causing the vapors to evaporate into the glass jar with the potato tubers. The heat gun was set at 350-550° F. (177-288° C.) on low blower speed setting and directed for 30-60 sec.

After each treatment, the filter paper was checked for wetness and smell, and when the paper was dry to the touch and lacked the aldehyde odor, it was considered evidence that there was no aldehyde left on the filter paper. Soon after treatment, the assembly (with the filter paper lids) was removed and replaced with a normal Mason jar lid and screwed tight. The jars were placed horizontally in a cool, dark place (22.8° C.) and tubers were taken out after 48 and 96 hours and evaluated for skin lesions/skin damage using a 6× magnification head loupe. The 10 results for this test are shown in Table 12.

TABLE 12

| | | | Total |
|---|---|---|---|
| | | | No. of |
| | No. of Lesions | | Lesions |
| Treatment (N = 5) | 48 h | 96 h | (3 tubers) |
| Trans-2-hexenal (T2H) | 10 | 8 | 18 |
| 0.15 mL/kg | | | |
| Trans-2-pentenal (T2P) | 6 | 10 | 16 |
| 0.10 mL/kg | | | |
| Trans-2-pentenal (T2P) | 8 | 8 | 16 |
| 0.15 mL/kg | | | |
| Trans-2-pentenal (T2P) | 15 | 16 | 31 |
| 0.20 mL/kg | | | |
| Trans-2-heptenal (T2HP) | 13 | 9 | 22 |
| 0.10 mL/kg | | | |
| Trans-2-heptenal (T2HP) | 13 | 14 | 27 |
| 0.15 mL/kg | | | |
| Trans-2-heptenal (T2HP) | 19 | 22 | 41 |
| 0.20 mL/kg | | | |
| Trans-2-decenal (T2D) | 10 | 15 | 25 |
| 0.10 mL/kg | | | |
| Trans-2-decenal (T2D) | 9 | 18 | 27 |
| 0.15 mL/kg | | | |
| Trans-2-decenal (T2D) | 17 | 36 | 53 |
| 0.20 mL/kg | | | |
| Control (water only) | 0 | 4 | 4 |
| 0.20 mL/kg | | | |

All 3 α-β unsaturated aldehydes exhibited phytotoxicity symptoms on potato. Trans-2-pentenal exhibited numerically same as Trans-2-hexenal but lower than Trans-2-heptenal. Trans-2-decenal was generally more phytotoxic.

### Example 5. Effect of Propylene Glycol to Reduce the Phytotoxicity of Trans-2-Decenal on Potatoes

Potato tubers were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of trans-2-decenal with or without propylene glycol was applied to the filter paper. Quickly thereafter, a heat gun equipped with temperature control set at a low blower speed, was used to heat the T2D/glycol mixture-loaded filter paper, causing the vapors to evaporate into the glass jar with the potato tubers. The heat gun was set at 350-550° F. (177-288° C.) on low blower speed setting and directed for 30-60 sec.

After each treatment, the filter paper was checked for wetness and smell, and when the paper was dry to the touch and lacked the T2D odor, it was considered evidence that there was no trans-2-decenal left on the filter paper. Soon after treatment, the assembly (with the filter paper lids) was removed and replaced with a normal Mason jar lid and screwed tight. The jars were placed horizontally in a cool, dark place (22.8° C.) and tubers were taken out after 48 and 96 hours and evaluated for skin lesions/skin damage using a 6× magnification head loupe. The results for this test are shown in Table 13.

TABLE 13

| | 48 h Post | 96 h Post | TOTAL |
|---|---|---|---|
| | Treatment | Treatment | No. of |
| | No. of | No. of | Lesions |
| Treatment (N = 5) | Lesions | Lesions | (5 tubers) |
| Control - Propylene glycol (PG) | 2 | 2 | 4 |
| only@ 0.15 mL/kg | | | |
| Trans-2-decenal @ 0.20 ml/kg | 11 | 12 | 23 |
| Trans-2-decenal @ 0.20 ml/kg + PG | 7 | 8 | 15 |
| @0.02 mL/kg (10:1) | | | |
| Trans-2-decenal @ 0.20 ml/kg + PG | 26 | 20 | 46 |
| @0.10 mL/kg (2:1) | | | |
| Trans-2-decenal @ 0.20 ml/kg + PG | 104 | 20 | 124 |
| @0.15 mL/kg (4:3) | | | |

The addition of Propylene glycol (1:10 ratio PG: T2D) to trans-2-decenal reduced the number of Lesions and the overall phytotoxicity of this α-β unsaturated aldehyde to potatoes. However, at 2:1 and 4:3 (T2D: PG), there was increased pitting/lesions which was unexpected. 1:10 ratio (T2D: PG) appears to be best to reduce phytotoxicity.

### Example 6. Effect of Propylene Glycol to Reduce the Phytotoxicity of Trans-2-Heptenal on Potatoes

Potato tubers were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of trans-2-decenal with or without propylene glycol was applied to the filter paper. Quickly thereafter, a heat gun equipped with temperature control set at a low blower speed, was used to heat the T2H/glycol mixture-loaded filter paper, causing the vapors to evaporate into the glass jar with the potato tubers. The heat gun was set at 350-550° F. (177-288° C.) on low blower speed setting and directed for 30-60 sec.

After each treatment, the filter paper was checked for wetness and smell, and when the paper was dry to the touch and lacked the T2H odor, it was considered evidence that there was no trans-2-decenal left on the filter paper. Soon after treatment, the assembly (with the filter paper lids) was removed and replaced with a normal Mason jar lid and screwed tight. The jars were placed horizontally in a cool, dark place (22.8° C.) and tubers were taken out after 48 and 96 hours and evaluated for skin lesions/skin damage using a 6× magnification head loupe. The results for this test are shown in Table 14.

TABLE 14

| | 48 h Post | 96 h Post | |
|---|---|---|---|
| | Treatment | Treatment | Total |
| | No. of | No. of | No. of |
| Treatment (N = 5) | Lesions | Lesions | Lesions |
| Control - Propylene glycol (PG) | 2 | 5 | 7 |
| only@ 0.075 mL/kg | | | |
| Trans-2-heptenal @ 0.15 ml/kg | 15 | 20 | 35 |
| Trans-2-heptenal @ 0.15 ml/kg + | 11 | 12 | 23 |
| PG @0.015 mL/kg (10:1) | | | |
| Trans-2-heptenal @ 0.15 ml/kg + | 7 | 8 | 15 |
| PG @0.030 mL/kg (5:1) | | | |
| Trans-2-heptenal @ 0.15 ml/kg + | 16 | 11 | 27 |
| PG @0.075 mL/kg (4:3) | | | |

The addition of Propylene glycol to trans-2-heptenal reduced the number of Lesions and the overall phytotoxicity of this α-β unsaturated aldehyde to potatoes. However, at 10:1 and 5:1 (T2heptenal: PG), appears to be best to reduce phytotoxicity. Increasing the PG ratio to 4:3 (T2Heptenal: PG) was not beneficial.

### Example 7. Effect of Propylene Glycol to Reduce the Phytotoxicity of Trans-2-Pentenal on Potatoes

Potato tubers were carefully weighed separately and loaded into 0.5 gal (1.89 liter) glass Mason jars. A 3 cm hole was drilled through two Mason jar lids wherein a #1 (5.5 cm) Whatman filter paper was inserted between the lids. Using a micropipette, a known amount of trans-2-pentenal with or without propylene glycol was applied to the filter paper. Quickly thereafter, a heat gun equipped with temperature control set at a low blower speed, was used to heat the T2P/glycol mixture-loaded filter paper, causing the vapors to evaporate into the glass jar with the potato tubers. The heat gun was set at 350-550° F. (177-288° C.) on low blower speed setting and directed for 30-60 sec.

After each treatment, the filter paper was checked for wetness and smell, and when the paper was dry to the touch and lacked the T2P odor, it was considered evidence that there was no trans-2-decenal left on the filter paper. Soon after treatment, the assembly (with the filter paper lids) was removed and replaced with a normal Mason jar lid and screwed tight. The jars were placed horizontally in a cool, dark place (22.8° C.) and tubers were taken out after 48 and 96 hours and evaluated for skin lesions/skin damage using a 6× magnification head loupe. The results for this test are shown in Table 15.

TABLE 15

| | 48 h Post | 96 h Post | |
|---|---|---|---|
| | Treatment | Treatment | Total |
| | No. of | No. of | No. of |
| Treatment (N = 5) | Lesions | Lesions | Lesions |
| Control - Propylene glycol | 4 | 4 | 8 |
| (PG) only @ 0.075 mL/kg | | | |
| Trans-2-pentenal @ 0.15 ml/kg | 15 | 20 | 35 |
| Trans-2-pentenal @ 0.15 ml/kg + | 10 | 10 | 20 |
| PG @0.015 mL/kg (10:1) | | | |
| Trans-2-pentenal @ 0.15 ml/kg + | 8 | 14 | 22 |
| PG @0.030 mL/kg (5:1) | | | |
| Trans-2-pentenal @ 0.15 ml/kg + | 11 | 13 | 24 |
| PG @0.075 mL/kg (4:3) | | | |

The addition of Propylene glycol to trans-2-pentenal at all ratios tested, reduced the number of Lesions and the overall phytotoxicity of this α-β unsaturated aldehyde to potatoes. However, there appears to be no benefit to increase the ratio of propylene glycol to the aldehyde to greater than 10:1 (T2heptenal: PG).

### Example 8. Phytotoxicity Profile of Three Unique Trans-2-Hexenal (T2H) Formulations Containing Glycols from Field Trials

Plants tested were potatoes, cucurbits, and turfgrass. Results are shown in Table 16.

TABLE 16

| | | | | Glycol | | | |
|---|---|---|---|---|---|---|---|
| Active | Formulation | | | Content in | | | |
| Ingredient/ | Concentration | | Formulation | Formulation | Rate | Application | Phytotoxicity |
| Formulation | of T2H | | Type | (g/L) | (gai/A) | Code | (%) |
| TRANS-2- | 167 | g/L | EC | <5.0% | 100 | 6 | 0* |
| HEXENAL-A | | | | | | applications | |
| | | | | | | total- made | |
| | | | | | | 7 days apart | |
| TRANS-2- | 167 | g/L | EC | <5.0% | 250 | 6 | 0* |
| HEXENAL-A | | | | | | applications | |
| | | | | | | total- made | |
| | | | | | | 7 days apart | |
| TRANS-2- | 167 | g/L | EC | <5.0% | 500** | 6 | 0* |
| HEXENAL-A | | | | | | applications | |
| | | | | | | total- made | |
| | | | | | | 7-14 days | |
| | | | | | | apart | |
| TRANS-2- | 816 | g/L | EC | <2.0% | 100 | 6 | 0* |
| HEXENAL-C | | | | | | applications | |
| | | | | | | total- made | |
| | | | | | | 7 days apart | |
| TRANS-2- | 816 | g/L | EC | <2.0% | 250 | 6 | 0* |
| HEXENAL-C | | | | | | applications | |
| | | | | | | total- made | |
| | | | | | | 7 days apart | |
| TRANS-2- | 816 | g/L | EC | <2.0% | 500** | 6 | 0* |
| HEXENAL-C | | | | | | applications | |
| | | | | | | total- made | |
| | | | | | | 7-14 days | |
| | | | | | | apart | |
| TRANS-2- | 168 | g/L | EC | <5.0% | 100 | 6 | 0* |
| HEXENAL-D | | | | | | applications | |
| | | | | | | total- made | |
| | | | | | | 7 days apart | |
| TRANS-2- | 168 | g/L | EC | <5.0% | 250 | 6 | 0* |
| HEXENAL-D | | | | | | applications | |
| | | | | | | total- made | |
| | | | | | | 7 days apart | |
| TRANS-2- | 168 | g/L | EC | <5.0% | 500** | 6 | 0* |
| HEXENAL-D | | | | | | applications | |
| | | | | | | total- made | |
| | | | | | | 7-14 days | |
| | | | | | | apart | |
| Ridomil Gold | 4 | lb/gal | SL | Unknown | 45.4 | 3 | 0* |
| (mefenoxam) | | | | | | applications | |
| | | | | | | total- made | |
| | | | | | | 14 days | |
| | | | | | | apart | |
| Serenade Opti | 262 | g/L | WP | Unknown | 149 | 6 | 0* |
| (Bacillus subtilis) | | | | | | applications | |
| | | | | | | total- made | |
| | | | | | | 7 days apart | |

*There was zero phytotoxicity at all ratings i.e. 7-10 days after each application and seasonal phytotoxicity (after 6 applications) is reported.
**Turf application rates.

### Example 9

Table 17 shows the phytotoxicity (no. of lesions/potato tuber) of pure Trans-2-hexenal and 5% (20:1) trans-2-hexenal: propylene glycol when treated as a vapor at the rate of 2 fl. oz (50 g) per tonne (1000 kg) or 0.06 mL/kg of potatoes.

TABLE 17

| | No. of Lesions/tuber after 30 days in cold storage | | |
|---|---|---|---|
| | | | T2H:Propylene |
| | Control | Trans-2-hexenal | glycol mixture |
| Potato | (water | (T2H), Pure | (5% or 20:1 ratio) |
| Variety | vapor) | @ 50 g/tonne | @ 50 g/tonne |
| Dark Red | 0.1 | 2.15 | 0.68 |
| Norland | | | |
| Russet | 0.08 | 1.03 | 0.43 |
| Burbank | | | |
| Snowden | 0.05 | 3.05 | 1.7 |
| Yukon Gold | 0.15 | 0.43 | 0.25 |

Addition of 20:1 (T2H: PG) or 5% propylene glycol to trans-2-hexenal decreased the phytotoxicity to all 4 varieties of potatoes.

While the invention has been described in terms of its preferred embodiments, those skilled in the art will recognize that the invention can be practiced with modification within the spirit and scope of the appended claims. Accordingly, the present invention should not be limited to the embodiments as described above but should further include all modifications and equivalents thereof within the spirit and scope of the description provided herein.

We claim:

1. A method for inhibiting growth of oomycetes, fungi, and bacterial pathogens on a locus of a plant, a plant, or plant part, comprising applying to the loci, plant, or plant part, a composition comprising
one or more C4-C10 alpha beta unsaturated aldehydes, and
one or more glycol solvents,
wherein the molar, volumetric, or weight ratio of the one or more C4-C10 alpha beta unsaturated aldehydes to the one or more glycol solvents ranges from 50:50 to 99:1, wherein the moles, volume, or weight of the one or more glycol solvents is sufficient to reduce phytotoxicity of the one or more C4-C10 alpha beta unsaturated aldehydes to the locus of the plant, the plant or the plant part compared to a composition which lacks the one or more glycol solvents, and wherein the composition is applied in an amount of 0.01-5 liters/hectare of a crop or 0.01-0.5 liters/1000 kg of produce, plants, or plant parts in storage.

2. The method of claim 1, wherein application of the composition controls a disease caused by an oomycete pathogen.

3. The method of claim 2, wherein the oomycete pathogen is selected from the group consisting of Phytophthora spp., Peronospora spp., Bremia spp., Albugo spp., Pythium spp., Phytopythium spp. and combinations thereof.

4. The method of claim 1, wherein application of the composition controls a disease caused by a fungal pathogen selected from the group consisting of Alternaria, Aspergillus, Botrytis, Colletotrichum, Ceratocystis, Diplodia, Monilinia, Penicillium, Phomopsis, Puccinia, Rhizopus, Mucor, Sclerotinia, Pseudocercospora, Ustilago, and combinations thereof.

5. The method of claim 1, wherein application of the composition controls a disease caused by a bacterial pathogen selected from the group consisting of Xanthomonas, Psuedomonas, Pectobacterium spp., and combinations thereof.

6. The method of claim 1, wherein the composition is applied before or after disease establishment to the loci of the plant, the plant or plant part before harvest of the plant or plant part.

7. The method of claim 6, wherein the composition is applied via foliar application.

8. The method of claim 6, wherein the composition is applied via a soil application.

9. The method of claim 8, wherein the composition is applied via an in-furrow, soil drenching of soil or soil less media, or seed treatment process.

10. The method of claim 1, wherein the composition is applied to the plant or plant part after harvest of the plant or plant part in storage.

11. The method of claim 10, wherein the composition is applied to bulbs, tubers, roots, fruits, vegetables, nuts, stems, or seeds.

12. The method of claim 1, wherein the plant or plant part comprises potatoes or citrus.

13. The method of claim 1, wherein the C4-C10 alpha beta unsaturated aldehyde is selected from the group consisting of trans-2-hexenal, trans-2-octenal, trans-2-pentenal, trans-2-nonenal, trans-2-heptenal, trans-2-decenal, and combinations thereof.

14. The method of claim 1, wherein the C4-C10 alpha beta unsaturated aldehyde is trans-2-hexenal.

15. The method of claim 1, wherein the glycol solvent comprises glycol ether, glycol ester, or glycol amine.

16. The method of claim 1, wherein the glycol solvent comprises a glycol selected from the group consisting of propylene glycol, dipropylene glycol, hexylene glycol, ethoxy diglycol, butylene glycol, and combinations thereof.

17. A composition, comprising
a C4-C10 alpha beta unsaturated aldehyde; and
a glycol selected from hexylene glycol and ethoxy diglycol,
wherein a ratio of the C4-C10 alpha beta unsaturated aldehyde to the glycol is from 50:50 to 99:1.

18. The composition of claim 17, wherein the C4-C10 alpha beta unsaturated aldehyde is selected from the group consisting of trans-2-hexenal, trans-2-octenal, trans-2-pentenal, trans-2-nonenal, trans-2-heptenal, trans-2-decenal, and combinations thereof.

19. The composition of claim 17, wherein the C4-C10 alpha beta unsaturated aldehyde is trans-2-hexenal.

20. The composition of claim 17, wherein the ratio is from 75:25 to 95:5.

21. The composition of claim 17, further comprising one or more polymeric surfactants.
